(19) United States
(12) Patent Application Publication
(10) Pub. No.: US 2019/0264440 A1
(43) Pub. Date: Aug. 29, 2019

(54) VAPOR DIFFUSIVE INSULATING WALL PANEL AND METHODS OF MAKING SAME

(71) Applicant: Atlas Roofing Corporation, Meridian, MI (US)

(72) Inventors: Theodore Alan GRANT, Muskegon, MI (US); Matthew Richard CAWSON, Caledonia, MI (US); Christopher John KREPLE, Holland, MI (US); Robert BUTKUS, Byron Center, MI (US); Robert Michael DEVER, JR., Dorr, MI (US)

(21) Appl. No.: 16/241,960

(22) Filed: Jan. 7, 2019

Related U.S. Application Data
(63) Continuation-in-part of application No. 15/424,646, filed on Feb. 3, 2017, now Pat. No. 10,174,503.

(51) Int. Cl. E04B 1/62; B32B 7/14; B32B 27/06; B32B 27/34; B32B 37/12

(52) U.S. Cl. CPC E04B 1/625; B32B 7/14; B32B 27/065; B32B 2419/00; B32B 37/1292; B32B 2307/724; B32B 27/34

(57) ABSTRACT

A laminated building sheathing (20) comprising a rigid foam board (22) and a vapor-permeable film facer (24). The vapor-permeable film facer (24) is adhered to the rigid foam board (22) by an adhesive (26) at non-continuous adhesive locations. The film facer (24) is vapor-permeable, and an extent of non-continuity of the adhesive with respect to area of the rigid foam board is controlled to provide a desired balance between (1) sufficient vapor permeability to conduct vapor to the exterior of the sheathing and (2) a minimum surface area required to effect sufficient adhesion of the film facer to the rigid foam board. In another of its example aspects, a laminated building sheathing comprises a rigid foam board, the rigid foam board comprising a first major surface and a second major surface parallel to the first major surface. The first major surface is configured for being covered by cladding; the second major surface is configured for contact with a building. A drainage channel is formed on the first major surface and a moisture distribution feature being provided on the second major surface. In an example embodiment and mode, the moisture distribution feature comprises an air passageway

This application is a continuation-in-part of U.S. patent application Ser. No. 15/424,646, filed Feb. 3, 2017, U.S. patent Ser. No. 10/174,503, which is hereby incorporated by reference herein.

### BACKGROUND

### I. Technical Field

The present invention relates to rigid exterior insulation sheathings that have been constructed to provide vapor transfer while maintaining functional barrier sealing, and methods for preparing and installing the same, and building constructions built using same.

### II. Related Art and Other Considerations

Many buildings are constructed to have one or more types of sheathing to attach to and cover components of a frame, such as studs or roof joists, for example. Some types of sheathing take the form of boards, such as plywood boards, oriented strandboard (OSB), or rigid foam boards. The sheathing is typically overlaid by some type of cladding, such as stucco, siding, brick, etc.

Rigid foam boards are generally tough, lightweight, and resistant to degradation and have many common uses in building and structural materials, such as, sheathing in the form of rigid foam board exterior insulation. As part of a wall assembly, rigid foam board provides a continual layer of thermal resistance, often in conjunction with other wall layers that are used to perform other functions such as to control air infiltration, bulk water intrusion, vapor transmission, and resistance to wind pressure. Accordingly, a need has arisen for rigid foam boards that can perform these other wall functions in addition to thermal resistance.

Recently, rigid foam insulation boards have been tested to demonstrate resistance to bulk water intrusion and air passage through the wall. These products rely on the natural skin of the foam board or “facers” laminated to the foam board, in conjunction with edge sealing and penetration flashing, to create barrier assemblies. A facer may be any type of covering, e.g., film, which is secured, e.g., laminated or adhered, to one or both sides of the rigid foam board, or a coating. The combination of foam board, flexural resistance, and/or facer tension create assemblies that serve as the primary wind barrier of the wall. Bracing technology is now available in the model building codes that negates the need for continual structural sheathing. As a result, walls utilizing rigid foam sheathing may now be built without use of traditional weather resistant barriers such as #15 asphalt felt or plastic housewrap, and without structural wood sheathing. The rigid foam sheathing controls air, water, thermal resistance, exterior wall water vapor passage, and the transition point of water vapor to liquid.

Unlike #15 asphalt felt paper or plastic housewrap where the layers are overlapped and material is wrapped to avoid penetration, rigid foam sheathing barriers (e.g., water or air) must rely on tape, caulk, edge shaping, and/or flashings to seal intersections of adjoining panels or transitions to windows, doors, roofs, and other parts of the building. Thus the surface of the foam sheathing must be sealable for the system to replace these wrap-type building materials.

A primary advantage of using film facers on rigid foam panels is the use of adhesive to bond the facer to the board in lieu of fasteners used with building wraps, eliminating many wall penetrations. Another advantage is the durability of these facers at a cost 5 to 10 times less than traditional building wrap materials. Film facers are desirable where self-sealing washers on fasteners are used, as the smooth film presents an ideal substrate for sealing without the need for additional caulk. The water barrier property of films is well understood, capable of withstanding much higher water pressure than is encountered in wall construction applications. For these reasons, film facers may be the default weather resistant layers used for rigid foam plastic insulation panels.

Adhering film facers to rigid foam panels using traditional liquid adhesives requires high capital expenditures for equipment, and the resulting adhesive cost is prohibitive. It has been discovered that the technology used to heat seal films together can be used to heat laminate film facer to rigid foam boards. In this manner, a very thin layer of adhesive is coated onto the film facer while liquid, rapidly cooled to create a non-tacky surface, and the film facer is rolled up for supply to companies to later heat activate the adhesive layer. This is known as “extrusion coating” the adhesive to the film facer, and the extrusion must be continuous. Alternately, film facers can be produced in what is known as “blown film” technology, which can produce film facers with 3 to 9 layers of material, each being a separate continuous layer. Often the outer layer on one or both sides is capable of being activated via heat to adhere to adjoining materials. Regardless of extrusion or blown film origin, these films can be very economically adhered to rigid foam panels by feeding the film facer between a heated roll and the rigid foam, thus activating the adhesive which bonds to the rigid foam panel surface. The cost relative to use of liquid adhesives is 5 to 10 times less expensive using this technology, and the equipment is much less expensive as well.

Despite the advantages of film facers, one major disadvantage has persisted. The same attributes which render the materials as excellent water resistant barriers contribute to very poor water vapor transfer properties. In many climates and for various wall assemblies, it is desirable to promote water vapor transfer through the exterior wall assembly. Use of water vapor impermeable facers is seen as a drawback in some assemblies, and as unacceptable in others. In building applications, materials that are vapor retarders are separated by Class for water vapor permeance. Class I is less than 0.1 perm, Class II is between 0.1 and 1.0 perm, and Class III is between 1.0 and 10.0 perm. Often times Class III is desired by design professionals.

Water vapor permeability through various materials is well studied, and is crucial for industries such as food preservation. In many cases, water vapor transfer is seen as a problem, and so the creation of impermeable systems is the primary focus. Where these systems need to be “opened up” to encourage water vapor transmission, it is often accomplished through mechanical perforations. Perforations are disruptions through the continuous film, often circular but slits, squares, and almost any shape can be used. The size of these holes, the shape, distribution per surface area, even the orientation or elevation of the resulting film deformation, can provide precisely the desired water vapor transfer for the given application. Unfortunately, the degree of mechanical disruption required in films to attain enough water vapor permeance for building construction applications has proven to destroy the water resistant barrier properties of the film facers.

Building wraps that are used as water resistive barriers also have high water vapor permeance. It has been thought that these materials could be extrusion coated to allow heat activated adhesion to rigid foam panels. However, the much thicker and higher mass of these film facers renders them very difficult to drive sufficient heat through for activation of the adhesive. The resulting slow production throughput and high cost of the building wrap material effectively prices this solution out of the market.

The most popular film facer in the rigid foam panel industry is polypropylene film. Whether clear, colored, or metalized as foil, this film is very vapor impermeable. Polyester film possesses somewhat higher water vapor permeance. A nylon film that has a heat activated extrusion coating has proven valuable in the manufacture of paperback book covers. Nylon film without adhesive extrusion coating exhibits very high water vapor permeance that is desirable for the construction industry. Further, the film is known to possess excellent water resistant barrier properties. Unfortunately, extrusion coated nylon film facer and blown nylon film facer with an adhesive layer has been found to have insufficient vapor permeability to meet the water vapor permeance needs of the construction industry. Other vapor permeable films prevalent in the medical, food preservation, or filtration industries such as silicone, polycarbonate, polystyrene, etc are also available for construction applications.

In commercial areas outside of building products there are many ways to apply the traditional “wet” non-heat activated adhesive that result in non-continuous adhesive surface coverage, and in fact this is common as a way to reduce adhesive application and thus cost. The application of a non-continuous adhesive allows lamination of vapor permeable film without rendering it water vapor impermeable.

A rigid foam board panel may have a major surface disrupted by a pattern to create varying elevations of the major surface. Such a rigid foam board may be processed through a machine to apply adhesive only to the highest elevation of the panel surface, leaving the lower elevation without adhesive and thus without the vapor impermeable property of the adhesive. The lamination of a vapor permeable facer to the rigid foam board thus remains vapor permeable for the surface area that comprises the lower elevation of the panel surface, as the film is adhered only to the highest elevation of the rigid foam panel. Drawbacks to the use of wet lamination equipment are capital expense and a higher per unit cost of adhesive than thin heat activated film adhesives.

In building materials is often desired to guard against moisture accumulation should a leak occur in the assembly. Such leaks may occur due to improper flashing of openings in the envelope, poor transition details from roofs and walls, failed sealing methods, or any number of conditions created during the life of a structure. These leaks are often “point loads” of moisture on the surrounding building materials. While vapor permeable materials can aid in allowing vapor to escape the assembly, such materials may not always be sufficient to overcome the wetting events, particularly in areas where rain is excessive. At these “point loads” of high moisture construction materials may succumb to mold and rot.

Thus far no vapor permeable economical film facer for rigid foam insulation panels passes water resistive barrier and air barrier requirements, and also meets the cost limitations of alternatives, such as separately installing permeable wraps. A need thus remains for a rigid foam board that can serve as the vapor and air barrier while still providing hydrostatic pressure relief, hygric redistribution, bulk water drainage, and water vapor ventilation between the foam sheathing and the cladding.

### BRIEF SUMMARY

In one of its example aspects, the technology disclosed herein concerns a laminated building sheathing comprising a rigid foam board and a vapor-permeable film facer. The vapor-permeable film facer is adhered to the rigid foam board by an adhesive at non-continuous adhesive locations.

In example embodiment and mode, an extent of non-continuity of the adhesive with respect to area of the rigid foam board is controlled to provide a desired balance between (1) sufficient vapor permeability to conduct vapor to the exterior of the sheathing and (2) a minimum surface area required to effect sufficient adhesion of the film facer to the rigid foam board.

In an example embodiment and mode, the vapor-permeable film facer comprises nylon.

In an example embodiment and mode the adhesive is a heat-activated adhesive.

In an example embodiment and mode the adhesive comprises adhesive drops which are applied to either the vapor-permeable film facer or to the rigid foam board in a non-continuous manner.

In an example embodiment and mode the adhesive comprises adhesive strips which are applied to either the vapor-permeable film facer or to the rigid foam board in a non-continuous manner.

In an example embodiment and mode the adhesive is applied to the rigid foam board in a non-continuous manner whereby the vapor-permeable film facer is adhered to the rigid foam board in the non-continuous adhesive locations.

In an example embodiment and mode the adhesive is a powder adhesive.

In an example embodiment and mode the adhesive is applied to the vapor-permeable film facer in a non-continuous manner.

In an example embodiment and mode, the building sheathing further comprises a non-continuous adhesive film interposed between the rigid foam board and the vapor-permeable film facer. In an example implementation, the non-continuous adhesive film interposed is mechanically perforated.

In an example embodiment and mode, the rigid foam board comprising a first major surface and a second major surface parallel to the first major surface, the first major surface being at covered by the vapor-permeable film facer and the second major surface configured for attachment to a building, a drainage channel being formed on the first major surface to provide at least one recessed channel surface, and wherein the adhesive is selectively non-continuously applied with respect to the first major surface and the recessed channel surface.

In an example embodiment and mode, the adhesive is applied to one or the other but not both of the first major surface and the recessed channel surface.

In another of its example aspects the technology disclosed herein concerns a method of forming a laminated building sheathing. The method comprises positioning a rigid foam board whereby a major surface of the rigid foam board is oriented for an adhesive operation; and adhering a vapor-permeable film facer to the major surface of the rigid foam board by an adhesive at non-continuous adhesive locations with respect to the major surface of the rigid foam board.

In an example embodiment and mode, the method further comprises controlling an amount and extent of coverage of the adhesive so as to impart to the sheathing both (1) sufficient vapor permeability to conduct vapor to the exterior of the sheathing and (2) sufficient adhesion of the film facer to the rigid foam board.

In an example embodiment and mode, the adhesive is a heat-activated adhesive, and the method further comprises heat-activating the adhesive.

In an example embodiment and mode, the method further comprises applying the adhesive to the rigid foam board in a non-continuous manner whereby the vapor-permeable film facer is adhered to the rigid foam board in the non-continuous adhesive locations.

In an example embodiment and mode, the method further comprises applying adhesive drops to either the vapor-permeable film facer or to the rigid foam board in a non-continuous manner.

In an example embodiment and mode, the method further comprises applying adhesive strips to either the vapor-permeable film facer or to the rigid foam board in a non-continuous manner.

In an example embodiment and mode, the adhesive is a powder adhesive; and the method further comprises distributing granules of the powder adhesive on the rigid foam board in the non-continuous manner.

In an example embodiment and mode, the method further comprises applying the adhesive to the vapor-permeable film facer in a non-continuous manner.

In an example embodiment and mode, the method further comprises interposing a non-continuous adhesive film between the rigid foam board and the vapor-permeable film facer.

In an example embodiment and mode, the method further comprises applying the non-continuous adhesive film to a surface of the vapor-permeable film facer, and then overlaying the vapor-permeable film facer and the non-continuous adhesive film applied thereto on the rigid foam board. In an example implementation, the non-continuous adhesive film interposed is mechanically perforated.

In an example embodiment and mode, wherein the rigid foam board comprises a first major surface and a second major surface parallel to the first major surface, the first major surface being at covered by the vapor-permeable film facer and the second major surface configured for attachment to a building, a drainage channel being formed on the first major surface to provide at least one recessed channel surface, and the method further comprises selectively non-continuously applying the adhesive with respect to the first major surface and the recessed channel surface. In an example embodiment and mode, the method further comprises applying the adhesive to one or the other but not both of the first major surface and the recessed channel surface.

In another of its example aspects the technology disclosed herein concerns a laminated building sheathing and method of making same. The laminated building sheathing comprises a rigid foam board, the rigid foam board comprising a first major surface and a second major surface parallel to the first major surface. The first major surface is configured for being covered by cladding; the second major surface is configured for contact with a building. A drainage channel is formed on the first major surface and a moisture distribution feature being provided on the second major surface. In an example embodiment and mode, the moisture distribution feature comprises an air passageway.

In an example embodiment and mode, the laminated building sheathing further comprises a facer applied to one or both of the first major surface and the second major surface of the rigid foam board. In an example, non-limiting implementation, the facer comprises a vapor-permeable film.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is perspective view of a laminated building sheathing according to a non-limiting example embodiment.

FIG. 2 is an exploded view of an example embodiment and mode of the laminated building sheathing of FIG. 1 wherein discrete adhesive drops applied to a first major surface of the rigid foam board adhere the vapor-permeable film facer to the rigid foam board.

FIG. 3 is an exploded view of an example embodiment and mode of the laminated building sheathing of FIG. 1 wherein discrete adhesive drops applied to an underside major surface of vapor-permeable film facer adhere the vapor-permeable film facer to the rigid foam board.

FIG. 4 is an exploded view of an example embodiment and mode of the laminated building sheathing of FIG. 1 wherein discrete adhesive stripes or stripes are applied to a first major surface of the rigid foam board to adhere the vapor-permeable film facer to the rigid foam board.

FIG. 5 is an exploded view of an example embodiment and mode of the laminated building sheathing of FIG. 1 wherein a non-continuous adhesive film is interposed between the rigid foam board and the vapor-permeable film facer.

FIG. 6 is a flowchart illustrating a method of forming a laminated building sheathing according to an example embodiment and mode.

FIG. 7 is a schematic cross section view of an example apparatus for fabricating or producing the sheathing of the any of the example embodiments and modes of FIG. 2-FIG. 4 inclusive.

FIG. 8 is a schematic cross section view of an example apparatus for fabricating or producing a sheathing of the example embodiment and mode of FIG. 5.

FIG. 9 is a sectioned view of a laminated building sheathing comprising a rigid foam board which has a drainage pattern formed on its major surface.

FIG. 10 is an enlarged view of a portion of FIG. 9.

FIG. 11A-FIG. 11C are cross-sectioned views of a rigid foam board wherein features are formed on both major surfaces thereof according to differing implementations.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. That is, those skilled in the art will be able to devise various arrangements which, although not explicitly described or shown herein, embody the principles of the invention and are included within its spirit and scope. In some instances, detailed descriptions of well-known devices, circuits, and methods are omitted so as not to obscure the description of the present invention with unnecessary detail. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

As used herein and in the appended claims, the singular forms “a”, “an”, and “the” include plural reference unless the context clearly dictates otherwise. Thus, for example, reference to a “board” is a reference to one or more boards and equivalents thereof known to those skilled in the art, and so forth. Unless defined otherwise, all technical and scientific terms used herein have the same meanings as commonly understood by one of ordinary skill in the art. Although any methods and materials similar or equivalent to those described herein can be used in the practice or testing of embodiments of the present invention, the preferred methods, devices, and materials are now described. Nothing herein is to be construed as an admission that the invention is not entitled to antedate such disclosure by virtue of prior invention.

Aspects of the technology disclosed herein include the structure of new laminated building sheathing; a method of making the new laminated building sheathing; a building construction which utilizes the new laminated building sheathing; and a method of installing the new laminated building sheathing. Example embodiments and modes described herein may generally include rigid foam board; surface modifications on one or both faces to provide vapor permeable properties; lamination with at least one film facer; manufactured products made from such rigid foam board, surface modification, and film facer; sealing of such products to each other and other wall components to create water and air barriers; and methods for producing the products. The rigid foam board products of embodiments may provide resistance to thermal energy, water, water vapor, water pressure, air, and air pressure either as a single feature or any combination of these features. These and other aspects are described below with reference to representative, example embodiments and modes.

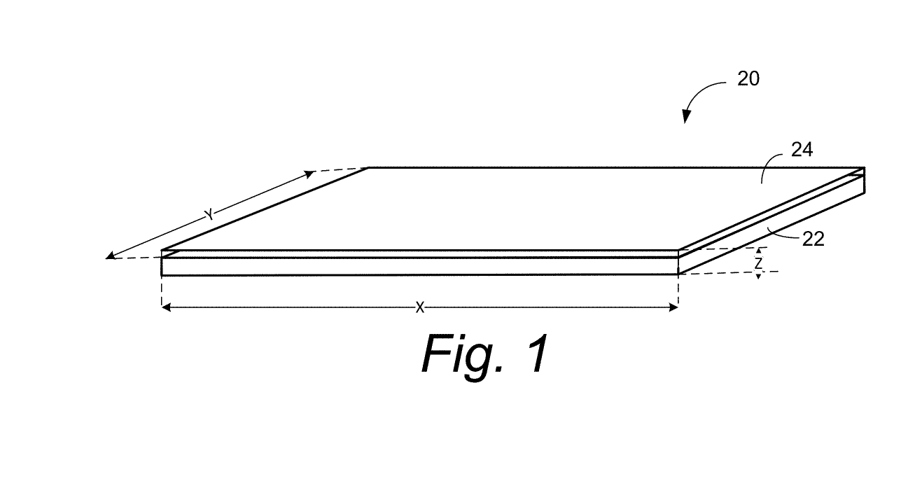

FIG. 1-FIG. 5 show representative panels or boards of laminated building sheathing 20 according to an example embodiments and modes of the technology disclosed herein. The laminated building sheathing 20, sometimes referred to herein as “sheathing”, comprises rigid form board 22 which is overlaid by facer 24. The laminated building sheathing 20, and the rigid form board 22 and facer 24 comprising the sheathing, have a three dimensional rectangular shape, extending in the X, Y, and Z directions as shown in FIG. 1.

The “rigid form board” of example embodiments and modes described herein and/or encompassed hereby may generally include foam boards manufactured using expanded polystyrene (EPS), extruded polystyrene (XPS), polyisocyanurate (PIR), phenolic foam, or other foam boards with compressive resistance exceeding 5 psi at 10% deformation. For example, EPS rigid foam boards provide an economical, functional, and ecological foam board option.

The facer 24 comprises a vapor-permeable film, and thus is known herein as a vapor-permeable film facer or vapor-permeable facer. The film 24 may be permeable to vapors or any liquid of concern in the building assembly, such as water, for example. Thus, in one example embodiment and mode the film facer 24 comprises a water vapor-permeable film facer. An example of a vapor-permeable film is nylon film. Other examples of vapor-permeable materials that may be used as the film facer 24 include silicone, polycarbonate, polystyrene, etc.

Either one or both faces of the rigid board 22 may have facer 24 applied. Ordinarily a facer is applied to a major surface of the rigid foam board 22 that is oriented toward a cladding, e.g., the cladding that is to be applied over the rigid foam board 22 in further construction assembly. In some instances it may be preferable, for reasons such as structural rigidity, to have the facer applied not only to the cladding-oriented major surface of the rigid foam board 22 but also to the opposite major surface of the foam board 22, e.g., to a major surface that is oriented to or faces an underlying structural component to which the foam board is to be attached. The facer 24 may cover the entire face of the rigid foam board 22, or the facer 24 can extend past the width or length edge or edges of the product.

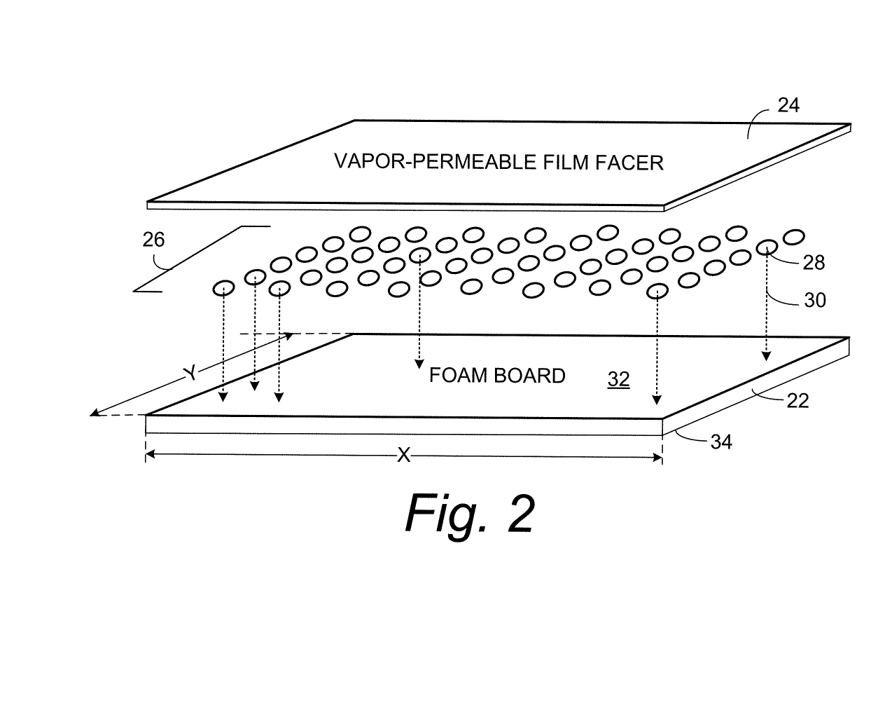

The vapor-permeable film facer 24 is adhered to the rigid foam board by an adhesive 26 at non-continuous adhesive locations. FIG. 2 shows that, in a first example embodiment and mode, the adhesive 26 takes the form of plural, discrete adhesive welds, spots, globs, or grains, all of which are collectively referred to as adhesive drops 28. In being “discrete”, the adhesive drops 28 are not connected to nor flow into one another. The adhesive drops 28 may be applied in a pattern, such as a grid or matrix pattern comprising columns and rows of adhesive drops 28 as shown in FIG. 2, or may be applied randomly. Moreover, the adhesive drops 28 may be of essentially the same size and droplet shape, or may vary in one or both size and shape. The adhesive drops 28 shown in FIG. 2 are essentially circular, but it should be understood that the adhesive drops 28 may take other shapes, which may depend at least to some extent on the configuration of an orifice or nozzle or broadcaster which administers the adhesive drops 28 onto a surface of the rigid foam board 22. The adhesive drops 28 may even take the form of grains of adhesive powder which are sprayed, sprinkled, or otherwise applied across a surface 32 of rigid foam board 22. Arrows 30 in FIG. 2 depict the fact that the adhesive drops 28 may be applied to the rigid foam board 22 in non-contiguous fashion, so that the adhesive drops 28 are applied to or formed on a surface of rigid foam board 22.

As shown in FIG. 2, the adhesive drops 28 are applied to a first major surface 32 of rigid foam board 22. FIG. 2 shows the first major surface 32 of rigid foam board 22 as being in an X-Y plane. The rigid foam board 22 has a second major surface 34 which is in an X-Y plane and opposite to the first major surface 32. In FIG. 2, after application of the adhesive drops 28 to the first major surface 32 of rigid foam board 22, the vapor-permeable film facer 24 may be overlaid onto the first major surface 32 of rigid foam board 22 and adhered thereto by the adhesive drops 28.

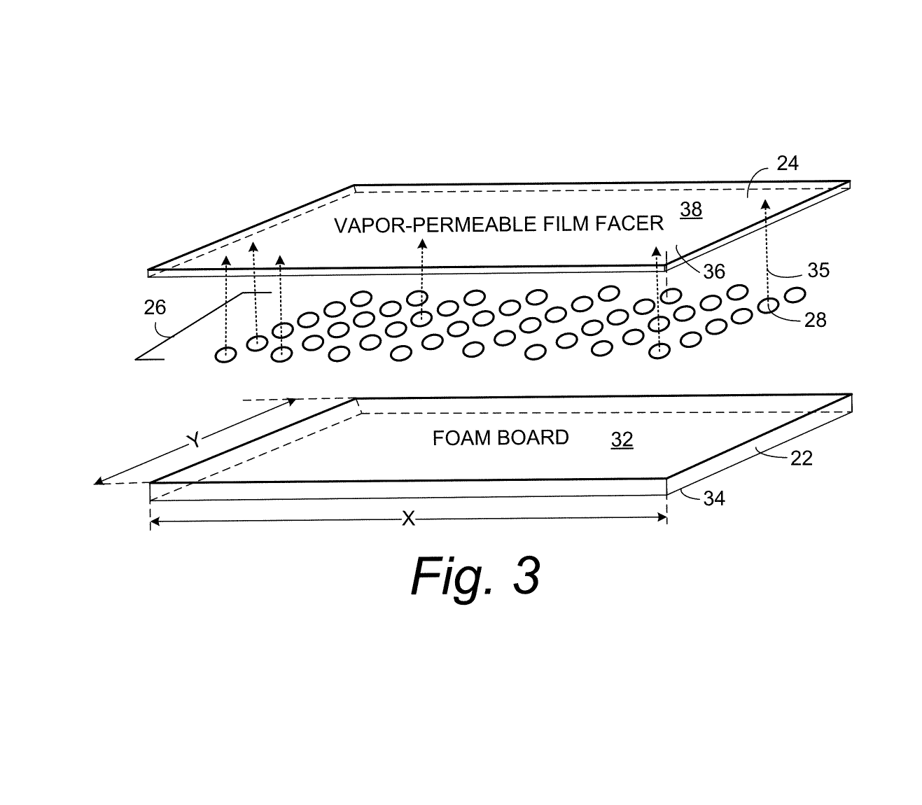

FIG. 3 shows another example embodiment and mode wherein the adhesive drops 28 may be initially applied to the vapor-permeable film facer 24 rather than to the rigid foam board 22. Arrows 35 in FIG. 3 depict the fact that the adhesive drops 28 may be applied to an underside major surface 36 of vapor-permeable film facer 24. The underside major surface 36 of vapor-permeable film facer 24 also extends in an X-Y plane, as does an upper side major surface 38 on the other side of vapor-permeable film facer 24. In FIG. 3, after application of the adhesive drops 28 to the underside major surface 36 of vapor-permeable film facer 24, the vapor-permeable film facer 24 may be overlaid onto the first major surface 32 of rigid foam board 22 and adhered thereto by the adhesive drops 28.

In both the example embodiment and mode of FIG. 2 and the example embodiment and mode of FIG. 3 the adhesive 26, in the form of adhesive drops 28, is applied to the rigid foam board in a non-continuous manner whereby the vapor-permeable film facer is adhered to the rigid foam board in the non-continuous adhesive locations. In particular, for both FIG. 2 and FIG. 3, the non-continuous adhesive locations are discrete locations pointed to by the arrows, e.g., arrows 30 in FIG. 2 pointing to corresponding non-continuous adhesive locations on first major surface 32 of rigid foam board 22 and arrows 35 in FIG. 3 pointing to corresponding non-continuous adhesive locations on the underside major surface 36 of vapor-permeable film facer 24.

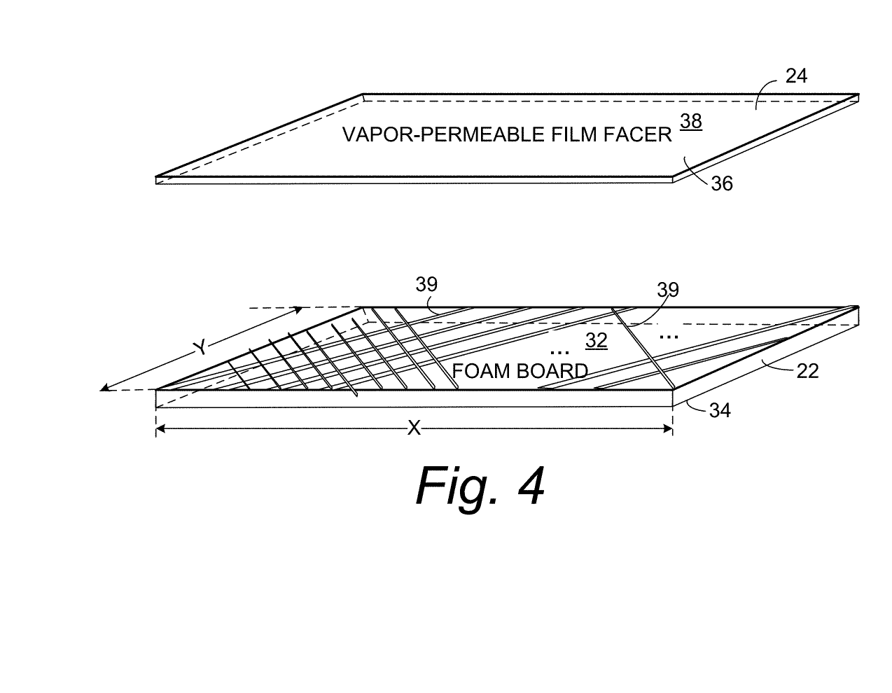

FIG. 4 shows an example embodiment and mode wherein adhesive 26 is applied in the form of discrete, spaced-apart adhesive stripes or strips 39 to a first major surface of the rigid foam board in order to adhere the vapor-permeable film facer 24 to the rigid foam board 22. The adhesive strips 39 are preferably spaced apart to provide the non-contiguous character to the adhesive 26. The adhesive strips 39 may be formed of any suitable width or pitch across the rigid foam board 22, and may be formed at any desirable angle. As shown in FIG. 4, the adhesive strips 39 may be formed in a criss-cross pattern wherein adhesive strips 39 of differing angular inclinations may cross or intersect one another. Moreover, the adhesive strips 39 need not be strictly linear as shown, but may have curvature or even have a sinuous or other pattern.

The adhesive strips 39 may be formed according to a pattern, such as the parallel and/or criss-crossing pattern of FIG. 4, or even a pattern forming circular or elliptical plateaus 34. The adhesive 26 need not be formed or applied in a pattern, but instead can be randomly formed or applied.

In the example embodiment and mode of FIG. 2, the example embodiment and mode of FIG. 3, and the example embodiment and mode of FIG. 4, the adhesive 26, whether in the form of adhesive drops 28 or adhesive strips 39, may be a powder adhesive. In being a “powder adhesive, the adhesive comprises at least some powdered constituent. Examples of powder adhesive include but are not limited to polyester, ethyl vinyl acetate, polyvinyl alcohol, starch, gelatin, and poly vinyl acetate.

In the example embodiment and mode of FIG. 2, the example embodiment and mode of FIG. 3, and the example embodiment and mode of FIG. 4, the adhesive 26, whether in the form of adhesive drops 28 or adhesive strips 39, may be a heat-activated adhesive. Examples of heat-activated adhesive include but are not limited to polyester, ethyl vinyl acetate, polyvinyl alcohol, starch, gelatin, and poly vinyl acetate

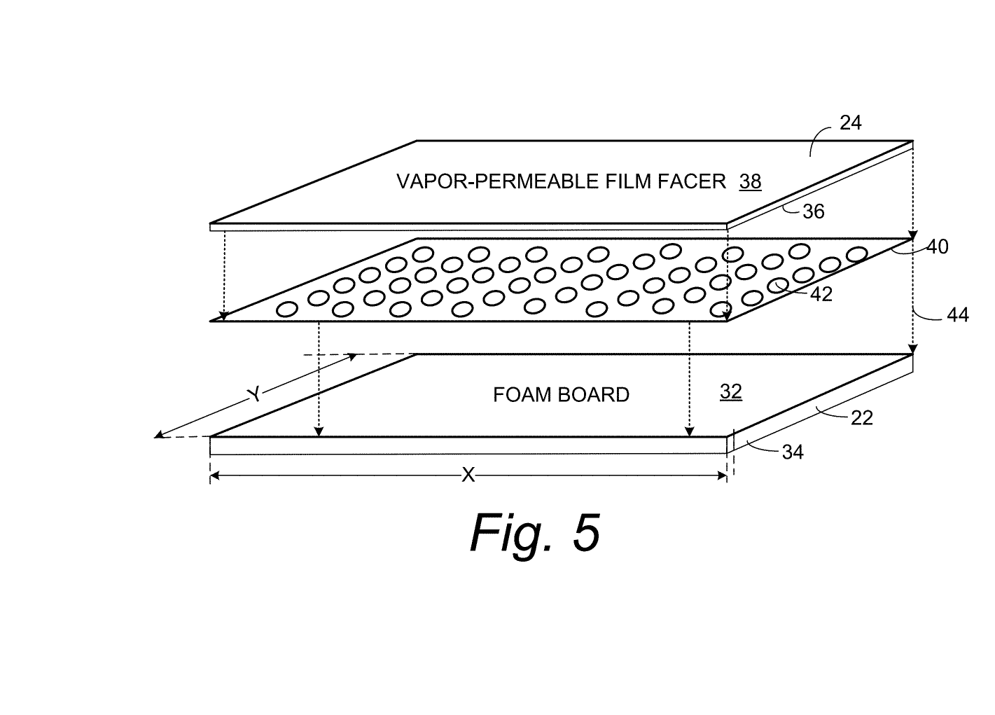

FIG. 5 shows that, in another example embodiment and mode, the adhesive 26 may take the form of a non-continuous adhesive film 40 interposed between the rigid foam board 22 and the vapor-permeable film facer 24. The non-continuous adhesive film 40 is preferably a film which, when unrolled, may acquire a planar configuration as shown in FIG. 5. The non-continuity of the adhesive is realized by holes, gaps, or perforations 42 formed in the non-continuous adhesive film 40. The perforations 42 are preferably formed in the non-continuous adhesive film 40 in a regular pattern, but a pattern per se need not be mandatory. Moreover, the perforations 42 may be of different sizes and shapes than shown, and may even be irregular in size and shape across the non-continuous adhesive film 40. The perforations 42 may be formed in any suitable manner, e.g., by molding the non-continuous adhesive film 40 with the perforations 42 or by mechanically cutting or perforating the film to yield the perforations 42.

Arrows 44 in FIG. 5 show that the non-continuous adhesive film 40 may be deposited on the first major surface 32 of rigid foam board 22. Preferably but not necessarily, the extent of the non-continuous adhesive film 40 in an X-Y plane is the same as for the first major surface 32 of rigid foam board 22.

In the example embodiment and mode of FIG. 5, the non-continuous adhesive film 40 may be applied to or overlaid on the first major surface 32 of rigid foam board 22. Thereafter the vapor-permeable film facer 24 may be overlaid onto the first major surface 32 of rigid foam board 22 and adhered thereto by the non-continuous adhesive film 40. It is also possible that the non-continuous adhesive film 40 may first be applied to underside major surface 36 of vapor-permeable film facer 24, and then the vapor-permeable film facer 24 with non-continuous adhesive film 40 adhered underneath may be overlaid onto the first major surface 32 of rigid foam board 22 and adhered thereto by the non-continuous adhesive film 40.

In each of the foregoing example embodiments and modes the adhesive 26, whether applied as adhesive drops 28 in the manner of FIG. 2 and FIG. 3, or whether applied as the adhesive strips 39 of FIG. 4, or whether applied as a non-continuous adhesive film 40 in the manner of FIG. 5, has been described as non-contiguous or non-continuous. The non-contiguous or non-continuity may be specified with reference to a an extent of a potential surface area interface, between the rigid foam board 22 and the vapor-permeable film facer 24, that does not have adhesive 26 interposed therebetween. For example, the non-contiguous or non-continuity may be specified with reference to a percentage of the potential surface area interface between the rigid foam board 22 and the vapor-permeable film facer 24 that does not have adhesive 26 interposed therebetween. The degree of non-contiguousness or non-continuity may depend on the strength of the adhesive material that forms the adhesive drops 28 or the non-continuous adhesive film 40. The stronger the adhesive property of the adhesive 26, the greater may be the degree of non-contiguousness or non-continuity of adhesive 26 between rigid foam board 22 and vapor-permeable film facer 24. An extent of non-continuity of the adhesive with respect to area of the rigid foam board is preferably chosen to provide a desired balance between (1) sufficient vapor permeability to conduct water to the exterior of the sheathing and (2) a minimum surface area required to effect sufficient adhesion of the film facer to the rigid foam board. In an example embodiment and mode, the percentage of the surface area interface between the rigid foam board 22 and the vapor-permeable film facer 24 does not have adhesive 26 interposed therebetween may be in a range of from about 20 percent to about 80 percent, the “about” being plus or minus 1%.

Thus, the amount and extent of coverage of the adhesive 26 is controlled so as to impart to the sheathing both (1) sufficient vapor permeability to conduct water vapor to the exterior of the sheathing and (2) sufficient adhesion of the film facer to the rigid foam board. In an example implementation, “sufficient vapor permeability” is considered to be at least 1 perm and “sufficient adhesion is considered to be at least 8 oz resistance upon 180 degree peel test of 3 inch wide film

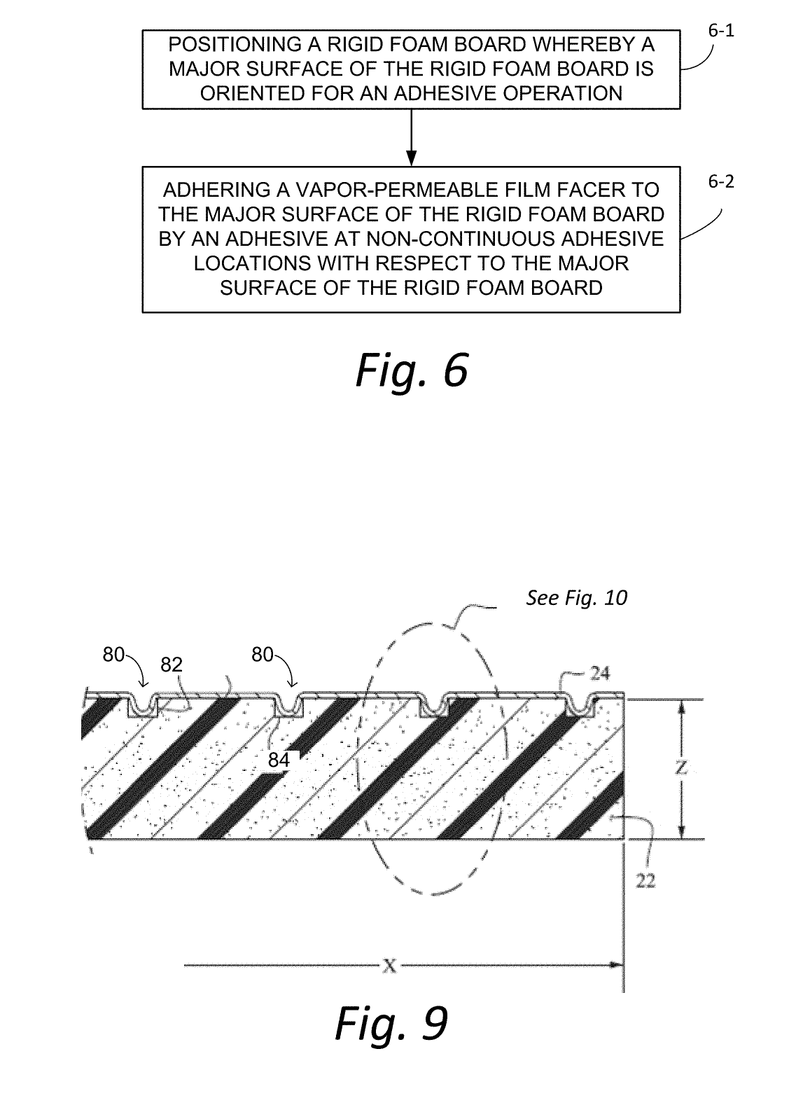

FIG. 6 illustrates a method of forming a laminated building sheathing according to an example embodiment and mode. The method of FIG. 5 is generic to the example embodiments and modes of FIG. 1-FIG. 4 inclusive. Act 5-1 comprises positioning a rigid foam board whereby a major surface of the rigid foam board is oriented for an adhesive operation. Act 5-2 comprises adhering a vapor-permeable film facer to the major surface of the rigid foam board by an adhesive at non-continuous adhesive locations with respect to the major surface of the rigid foam board. The method may also include the act of controlling the amount and extent of coverage of the adhesive 26 so as to impart to the sheathing both (1) sufficient vapor permeability to conduct water vapor to the exterior of the sheathing and (2) sufficient adhesion of the film facer to the rigid foam board.

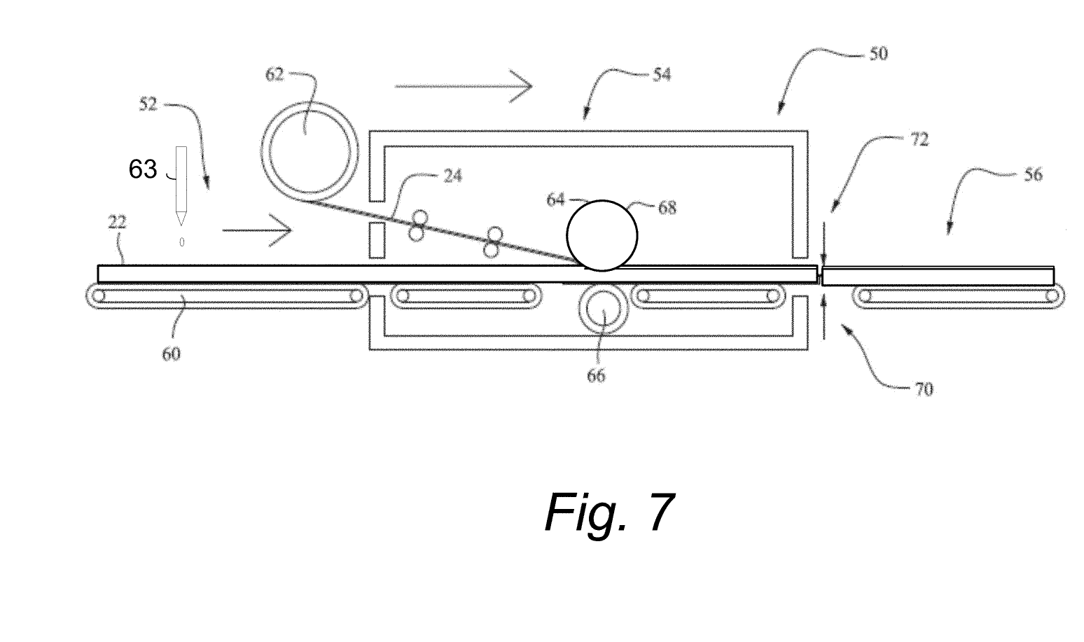

FIG. 7 shows, in schematic cross section, an example apparatus 50 for fabricating or producing the sheathing 20 of the any of the example embodiment and modes of FIG. 2-FIG. 4 inclusive. The apparatus of FIG. 7 comprises material supply station 52, lamination station 54, and post-processing station 56. The rigid foam board 22 is conveyed on a series of conveyors 60 toward lamination station 54, through lamination station 54, and out of the lamination station 54. The leftmost of the conveyors 60 shown in FIG. 7 is at the material supply station 52, other ones of the conveyors 60 are interior to the lamination station 54 and at the post-processing station 56.

In addition to one of the conveyors 60, the material supply station 52 includes vapor-permeable film facer 24 supply reel 62 and adhesive applicator 63. The adhesive applicator 63 may be a spray nozzle or droplet nozzle or the like, and discharges the adhesive, whether in powdered or other form, on the major surface of the rigid foam board 22 in non-continuous adhesive locations. Preferably plural adhesive applicators 63 are provided, e.g., across the Y or width direction of the rigid foam board 22. In some example embodiments and modes such as that of FIG. 4, the one or more adhesive applicators 63 may be moveable, e.g., with respect to the Y direction, in order to lay down the adhesive strips 39 according to a desired pattern or plan.

The lamination station 54 comprises lamination top roller 64 and lamination bottom roller 66 between which the rigid form board 22 is conveyed, with facer material fed to cover rigid form board 22 but under lamination top roller 64. Both lamination top roller 64 and lamination bottom roller 66 serve to nip or compress the combination of rigid form board 22 with overlaid facer material. For example, the nip or compression may be at a pinch pressure of 1/16″ to ⅜″.

The post-processing station 56 comprises, e.g., a cutter or blade 72 which cuts the rigid foam board 22 into desirably sized boards.

The sheathing producing apparatus 50 of FIG. 7 illustrates how the method of FIG. 6 may include an act of applying adhesive drops 28 or adhesive strips 39 between the rigid foam board and the vapor-permeable film facer. The act of applying adhesive drops 28 or adhesive strips 39 may occur by intermittently discharging the adhesive drops 28 from one or more adhesive applicators 63, or by selectively moving one or more adhesive applicators 63 in order to lay down the adhesive strips 39 on the first major surface 32 of rigid foam board 22.

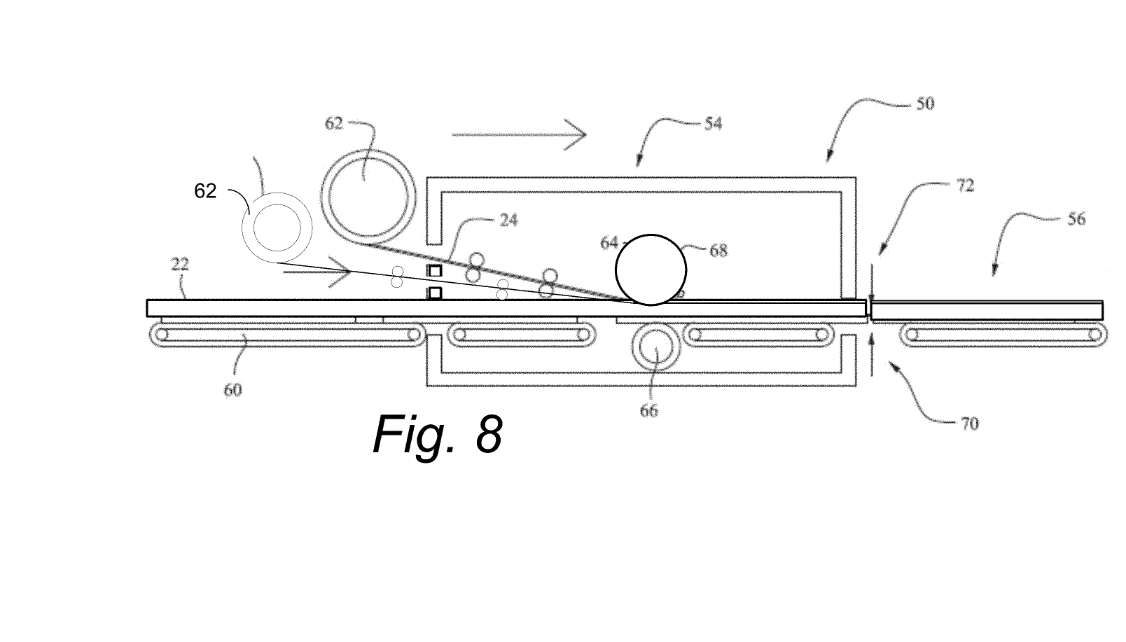

FIG. 8 shows, in schematic cross section, an example sheathing producing apparatus 50 for fabricating or producing the sheathing 20 of the example embodiment and mode of FIG. 5. As with FIG. 7, the apparatus of FIG. 8 comprises material supply station 52, lamination station 54, and post-processing station 56. Unlike the sheathing producing apparatus 50 of FIG. 7, the material supply station 52 of the sheathing producing apparatus 50 of FIG. 8 comprises station 78 for supplying the non-continuous adhesive film 40. The adhesive film supply station 78 may take the form of a rotatable spool from which the non-continuous adhesive film 40 may be fed or pulled in the conveyance direction. For the sheathing producing apparatus 50 of FIG. 8, the adhesive film supply station 78 is positioned in the material supply station 52 in lieu of the adhesive applicator 63 of the sheathing producing apparatus 50 of FIG. 7. Thus, the sheathing producing apparatus 50 of FIG. 8 illustrates how the method of FIG. 6 may include an act of interposing a non-continuous adhesive film between the rigid foam board and the vapor-permeable film facer. The interposing of the non-continuous adhesive film 40 may occur by feeding or pulling the non-continuous adhesive film 40 in between the rigid foam board 22 and the vapor-permeable film facer 24. The method may further comprise perforating the non-continuous adhesive film 40 prior to or during the supplying of the non-continuous adhesive film 40 into the lamination station 54.

In the example embodiments and modes thus far illustrated the rigid foam board 22 has comprised an essentially flat or planar first major surface 32. The technology disclosed herein may also be practiced and/or utilized for a rigid foam board 22 that has one or more features provided therein/thereon, including feature(s) that impart a non-flat or irregular contour to one or both of the first major surface 32 and the second major surface 34 of rigid foam board 22.

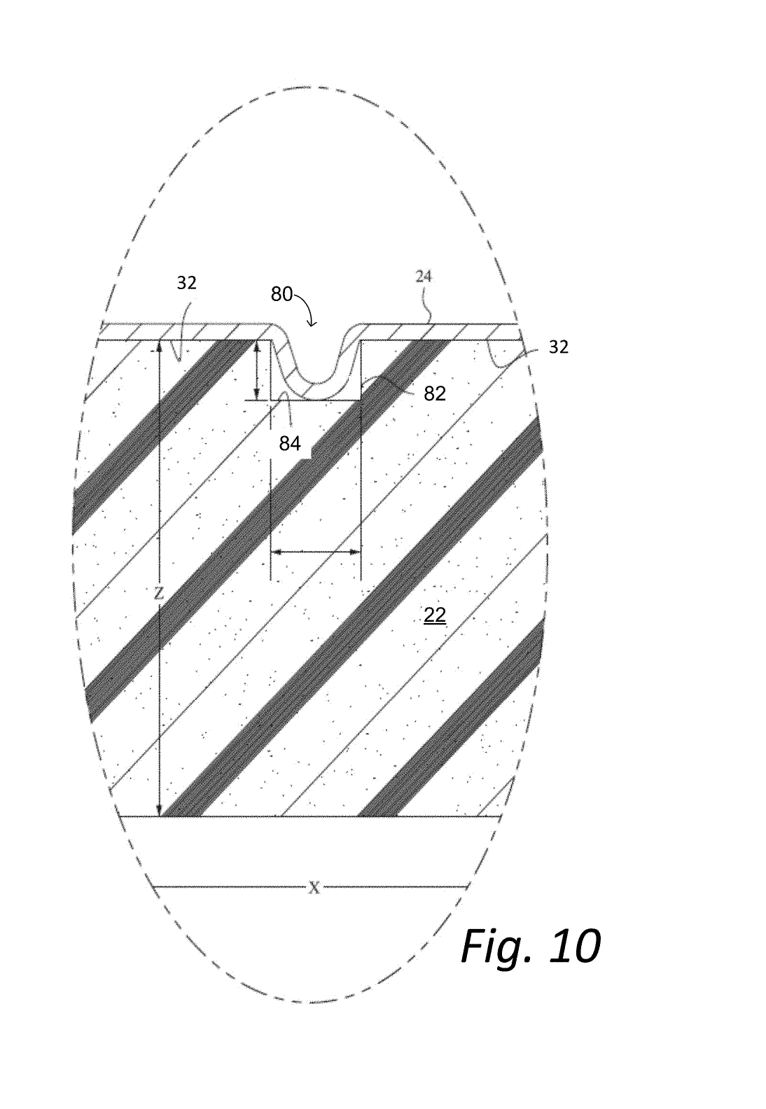

For example, one or both of the first major surface 32 and the second major surface 34 of rigid foam board 22 may be provided with one or more, and preferably a pattern, of drainage or diffusion channels formed thereon. For example, FIG. 9 shows an enlarged portion of a section of sheathing board 20 wherein the rigid foam board 22 has a drainage pattern formed on its major surface 32. As shown in FIG. 9 and in an even more enlargement of FIG. 10, the drainage pattern comprises at least one but preferably plural drainage channels 80. As shown in FIG. 9 and FIG. 10, the drainage channels 80 have essentially a U-shape. The drainage channels 80 are said to have essentially the shape of the letter U since channel sidewalls 82 are essentially at ninety degree angles (plus or minus 5 degrees) with respect to the major surface 32 of rigid form board 22 and to channel floor 84, also known as channel surface 84.

The drainage pattern may be any suitable pattern, one example being a pattern of drainage channels 80 which extend in the X-Y plane and have a depth in the Z direction. In an example implementation the drainage channels 80 may extend diagonally across rigid form board, so that the drainage pattern 30 has an overall criss-cross configuration to form plural diamond-shaped plateaus on the major surface of rigid form board 22. The facer 24 is configured to cover the major surface of the rigid form board 22 and to essentially conform to the drainage pattern. Since the facer 24 may cover the rigid form board 22, the drainage pattern may be replicated in facer 24.

For the example embodiments and modes in which a surface feature such as a drainage pattern is formed, the adhesive 26 may be applied or interposed between the rigid foam board 22 with its drainage channels 80 and the vapor-permeable film facer 24, in manners such as already described herein with reference to other example embodiments and modes. The location and extent of applications of the adhesive 26 may be random or according to a pattern. The location and extent of applications of the adhesive 26 may be either with regard or without regard to surface features, such as drainage channels 80 for example, on the first major surface 32 of rigid foam board 22. In example implementations in which the adhesive 26 is applied in consideration of such features, e.g., in example embodiments and modes wherein a drainage channel 80 is formed on the first major surface 32 of rigid foam board 22 to provide at least one recessed channel surface, the adhesive 26 may be selectively non-continuously applied with respect to the first major surface and the recessed channel surface. That is, in one example implementation the adhesive 26 may be applied or laid over some or all of the first major surface 32 of rigid foam board 22 but not in or on the channel floor 84. In another alternative example implementation, the adhesive 26 may be applied to or overlay only all or portions of the channel floor 84. A further understanding of the configuration and use of drainage channels 80 and other examples of drainage patterns are described in U.S. patent application Ser. No. 15/424,646, filed Feb. 3, 2017, which is incorporated herein by reference in its entirety.

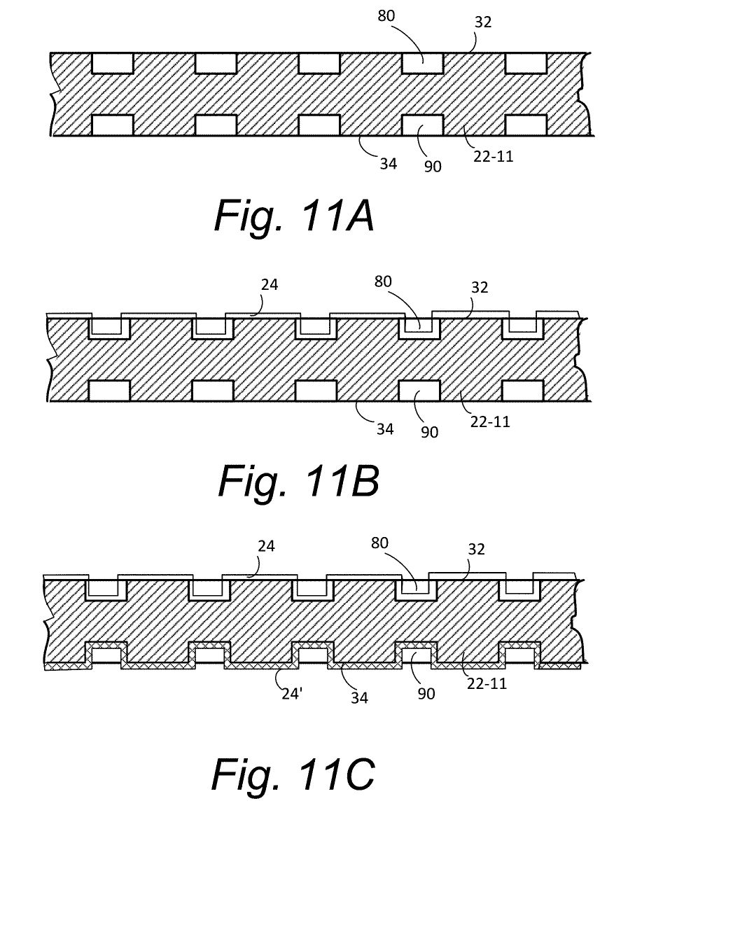

As mentioned above, one or both major surfaces of the rigid foam board may have features, such as a space, passageway, channel, or a pattern of spaces, channels, or passageways, formed thereon/therein. Where the feature-provided side of the rigid foam board faces a moisture sensitive component in the building assembly, such features(s) or pattern may serve to accommodate hygric redistribution of moist air within the assembly as opposed to drainage. FIG. 11A shows a cross section of an example rigid foam board 22-11 wherein features are formed on both the first major surface 32 of rigid foam board 22-11 and the second major surface 34. The rigid foam board 22-11 of this example embodiment and mode may or may not have a facer applied to either of its major surfaces. In other words, the rigid foam board 22-11 may have no facer applied at all to the rigid foam board 22-11 in the manner shown in FIG. 11A; or may have a facer 24 applied to only one of its first major surface 32 and second major surface 34 as shown in FIG. 11B; or may have facers 24, 24′ applied to both its first major surface 32 and its second major surface 34 as shown in FIG. 11C. The facers shown in the example embodiments and modes of FIG. 11A-11C may be any suitable type of facer material, and may be but are not limited to the vapor-permeable type facers described herein.

A distinguishing feature of rigid foam board 22-11 is that both major surfaces of rigid foam board 22-11 have features formed therein. Features such as channels have been provided in a rigid foam board, but only on a major surface of the rigid foam board to which cladding is applied. Heretofore features, such as spaces or channels or passageways, have not been provided on the second major surface 34, and it would have been considered as pointless to do so. Thus features such as passageways or channels or spaces have not heretofore been provided on both major surfaces of the rigid foam board, and such features have not been included on the second major surface, that is the surface that is opposite a cladding-contacted surface, of the rigid foam board 22-11.

Thus, as a separate feature, the present technology disclosed herein provides moisture distribution features 90 such as passageways, spaces or channels on a major surface of the rigid foam board 22-11 that is opposite to the cladding-contactable surface, e.g., second major surface 34 as shown in each of FIG. 11A-11C. As mentioned above, at certain “point loads” of high moisture construction materials may succumb to mold and rot. The technology disclosed herein advantageously provides moisture distribution 90 in the form of spaces, pathways, and/or channels in the rigid foam board 22-11 on a surface thereof, e.g., second major surface 34, to distribute moist air between the second major surface 34 of rigid foam board 22-11 and frame structure to which the rigid foam board 22-11 is to be attached. The spaces, pathways, or channels which serve as moisture distribution features 90, also referred to herein as air pathways 90, are provided in the second major surface 34 of the rigid foam board 22-11 to distribute moist air away from an area that as a leak to an area that is dry. Once the moist air is distributed within the air pathways 90 formed in the second major surface 34, the vapor-permeable construction of the rigid foam board 22 including the vapor-permeable film facer 24 allows the moisture to dissipate over time. The distribution of the moist air through the air pathways 90 may be considered as a lateral distribution, while the vapor-permeability provided by the vapor-permeable film facer 24 may be considered as a perpendicular distribution of vapor, e.g., perpendicular to a major surface of rigid foam board 22-11. The hygric redistribution on the second major surface 34 as facilitated by the air pathways, combined with the vapor-permeable film facer 24, together preserve moisture sensitive materials from damage due to point load moisture accumulation.

The moisture distribution features 90 may take any desired configuration, including diagonal or criss-crossing channels, linear and/or intersecting channels, or be formed in accordance with any suitable pattern such as those understood from U.S. patent application Ser. No. 15/424,646, filed Feb. 3, 2017, which is incorporated herein by reference in its entirety. Although the drainage channels 80 and moisture distribution features 90 are shown in FIG. 11A-FIG. 11C as being aligned in the Z direction of the rigid foam board 22, such not need be the case since, as mentioned above, the patterns or schemes for the respective features, e.g., the drainage channels 80 and the moisture distribution features 90, may be different.

For the example embodiment and mode of FIG. 11C, the facer 24′ may lie in the troughs of the moisture distribution features 90 when the facer 24′ is applied before the moisture distribution features 90 are formed. However, should the moisture distribution features 90 be formed on the second major surface 34 prior to application of the facer 24′, the facer 24′ may not dip into the troughs of the moisture distribution features 90 but instead may lie in essentially planar fashion on the second major surface 34.

Sealing edges of the product, e.g., the building sheathing, either to each other or to other wall components to create a water and air barrier assembly, may be accomplished through taping, flashing, caulks, or liquid applied coatings. For some example embodiments and modes taping is an economical, robust, and permanent sealing method for the wide range of substrates encountered in a wall assembly.

The technology disclosed herein includes an integral water and air sealant layer. The technology disclosed herein does not require separate coverage of the wall with a water or air barrier building wrap, and it presents the ability to seal using tapes and flashing materials much more common and economical than liquid or spray applied coatings. Further, the long term durability of tapes and flashing materials are well understood, while it is possible that liquid applied sealants, such as is seen with flaking paint, are not long term sealant solutions.

The following non-limiting example illustrates example method and materials that may be used to implement example aspects of the technology disclosed herein.

### Example 1

In the following example the effectiveness the vapor permeability of one example embodiment was assessed. All tests were carried out in accordance with ASTM E96 “Standard Test Methods for Water Vapor Transmission of Materials”, both the desiccant Method A (simulates low humidity performance), and the wet cup Method B (simulates high humidity performance). Briefly, the test sample is sealed opposite a chamber containing desiccant or water, and change in weight on the opposite side of the chamber over time is used to calculate water vapor transmission properties.

Test samples were prepared as follows: EPS rigid board was run through a heated roll after powder adhesive was dispersed loosely in non-continuous form on the top surface. As the rigid foam board was passed under a heated roll, plain nylon film with no extrusion coating was pinched between the powder-coated rigid foam board and the facer using the heated roll. The heat from the hot roll transmitted through the nylon film to melt the powder adhesive, which under compression from the roller created adhesion between the film and the rigid foam board. Samples were also produced using traditional polypropylene film with continuous heat activated extrusion adhesive as supplied with the film. The samples were assessed to compare performance.

Samples were collected to conduct 180 degree peel tests to assess whether this lamination technology was sufficient for the application. The resulting peel strengths of the powder adhesive product proved almost double the traditional heat activation films. Samples were subjected to prolonged water immersion in conjunction with mechanical stress, with no delamination observed. Samples tested for water vapor permeance resulted in values 10 to 20 times higher for the nylon film system with powder adhesive versus the traditional polypropylene film extrusion heat activated system, easily qualifying the finished rigid foam board and laminate system as a Class III vapor retarder (1.0 to 10.0 perm). The nylon faced boards were assembled to a wall assembly, sealed and flashed with tape, and passed a 2 hour test for rain exposure under negative pressure with no leaks, to establish water resistive barrier performance. Air resistance testing was conducted to prove that the system qualifies as an air barrier material.

Thus, as understood at least with partial reference to the foregoing and ensuing example embodiments and modes, facer 24 may be applied or adhered to rigid form board 22 using any number of application technologies, such as lamination, adhesive application including spot adhesive. or any variation of adhesive application pattern. Any adhesive that is chemically compatible with rigid foam board 22 may be used. As described herein, in an example embodiment and mode heat activated powder polymer adhesive on one side of a laminate (e.g., facer 24 or rigid foam board 22) with application of one half to two grams polymer adhesive per square foot surface area creates sufficient bond to adhere to rigid foam board 22.

The non-continuous application of the adhesive 26 with the resultant randomly non-applied surface is just one, non-limiting example of a disrupted adhesive pattern that provides the non-continuity of the adhesive 26.

In a non-limiting example embodiment and mode, the technology disclosed herein preferably employs a nylon film as the vapor-permeable facer 24. Nylon film is not commonly used in building construction. Yet nylon film has the surprising desirable attribute of becoming more vapor permeable as relative humidity increases. In other words, as conditions are created where drying is more important, the nylon film allows more water vapor transmission. Therefore, in at least some example embodiment and modes, a heat activated adhesive in the form of a powder is applied to the rigid foam board in a non-continuous pattern. The powder has the advantage of very low cost, very aggressive bond, and ease of maintaining a non-continuous layer. The rigid foam board with powder adhesive sprinkled on may be processed through a heated roller simultaneously with the nylon film intervening, resulting in the nylon film facer adhered to the rigid foam board in non-continuous form. Where the adhesive is not present, the nylon film facer maintains sufficient vapor permeability for the product to conduct water vapor to the exterior of the building in construction applications. The amount of areas without adhesive is limited by the minimum surface area required to effect sufficient adhesion of the film facer for durability of the rigid foam insulation panel. Other adhesives may be substituted for the heat activated powder, with respect to their greater expense or inferior adhesive properties. Other films may be substituted for the nylon film, with respect to their greater expense or inferior vapor permeability. The adhesive, whether powder or otherwise, can also be applied to the film facer in non-continuous manner, cooled, rolled up, and used later in the above described process to heat activate the film facer onto rigid foam board.

While blown films with heat activated adhesive properties, and extrusion coatings with heat activated adhesive properties are continuous layers, it is possible to mechanically perforate films produced in this manner to obtain sufficient permeability for construction applications where increased water vapor permeance is desired. However, such mechanical perforation renders the air barrier and water resistive barrier properties of the film ineffective. By taking a mechanically perforated film and using its adhesive properties to adhere it onto a vapor permeable, non-perforated film, in effect a non-continuous adhesive layer may be created in the new composite of the two films. In this manner, a water vapor permeable film is produced with no degradation of water resistive or air barrier properties, yet may be heat activated onto rigid foam board in later processing. The mechanically disrupted film in the composite that is facing the rigid foam board becomes the functional non-continuous adhesive layer, and the vapor permeable continuous film facing away from the rigid foam board serves as the water resistive barrier and air barrier. The composite film may also be produced online by feeding mechanically disrupted adhesive film and continuous vapor permeable film from two separate rolls to meet between a heat activation roller and rigid foam board, exiting the machine as a bi-layered film adhered to the rigid foam board.

Applying powder adhesive to the foam board, or to the facer, may be conducted using powder adhesive applicators known to those skilled in the art. Coincidental spooling of two facers onto a heat activated roller & rigid foam board using roll handling technology is also easily done using heat activated adhesive equipment known to those skilled in the art. These material handling devices are only briefly described to avoid obscuring the subject matter of the art.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A laminated building sheathing comprising:
a rigid foam board;
a vapor-permeable film facer adhered to the rigid foam board by an adhesive at non-continuous adhesive locations.

2. The sheathing of claim 1, wherein vapor-permeable film facer comprises nylon film.

3. The sheathing of claim 1, wherein an extent of non-continuity of the adhesive with respect to area of the rigid foam board is controlled to provide a desired balance between (1) sufficient vapor permeability to conduct vapor to the exterior of the sheathing and (2) a minimum surface area required to effect sufficient adhesion of the film facer to the rigid foam board.

4. The sheathing of claim 1, wherein the adhesive is a heat-activated adhesive.

5. The sheathing of claim 1, wherein the adhesive comprises adhesive drops which are applied to either the vapor-permeable film facer or to the rigid foam board in a non-continuous manner.

6. The sheathing of claim 1, wherein the adhesive comprises adhesive strips which are applied to either the vapor-permeable film facer or to the rigid foam board in a non-continuous manner.

7. The sheathing of claim 1, wherein the adhesive is applied to the rigid foam board in a non-continuous manner whereby the vapor-permeable film facer is adhered to the rigid foam board in the non-continuous adhesive locations.

8. The sheathing of claim 7, wherein the adhesive is a powder adhesive.

9. The sheathing of claim 1, wherein the adhesive is applied to the vapor-permeable film facer in a non-continuous manner.

10. The sheathing of claim 1, further comprising a non-continuous adhesive film interposed between the rigid foam board and the vapor-permeable film facer.

11. The sheathing of claim 10, wherein the non-continuous adhesive film interposed is mechanically perforated.

12. The sheathing of claim 1, the rigid foam board comprising a first major surface and a second major surface parallel to the first major surface, the first major surface being at covered by the vapor-permeable film facer and the second major surface configured for attachment to a building, a drainage channel being formed on the first major surface to provide at least one recessed channel surface, and wherein the adhesive is selectively non-continuously applied with respect to the first major surface and the recessed channel surface.

13. The sheathing of claim 12, wherein the adhesive is applied to one or the other but not both of the first major surface and the recessed channel surface.

14. A method of forming a laminated building sheathing comprising:
positioning a rigid foam board whereby a major surface of the rigid foam board is oriented for an adhesive operation;
adhering a vapor-permeable film facer to the major surface of the rigid foam board by an adhesive at non-continuous adhesive locations with respect to the major surface of the rigid foam board.

15. The method of claim 14, wherein vapor-permeable film facer comprises nylon film.

16. The method of claim 14, further comprising controlling an amount and extent of coverage of the adhesive so as to impart to the sheathing both (1) sufficient vapor permeability to conduct vapor to the exterior of the sheathing and (2) sufficient adhesion of the film facer to the rigid foam board.

17. The method of claim 14, wherein the adhesive is a heat-activated adhesive, and wherein the method further comprises heat-activating the adhesive.

18. The method of claim 14, further comprising applying the adhesive to the rigid foam board in a non-continuous manner whereby the film facer is adhered to the rigid foam board in the non-continuous adhesive locations.

19. The method of claim 18, further comprising applying adhesive drops to either the film facer or to the rigid foam board in a non-continuous manner.

20. The method of claim 18, further comprising applying adhesive strips to either the film facer or to the rigid foam board in a non-continuous manner.

21. The method of claim 18, wherein the adhesive is a powder adhesive; and
wherein the method further comprises distributing granules of the powder adhesive on the rigid foam board in the non-continuous manner.

22. The method of claim 14, further comprising applying the adhesive to the film facer in a non-continuous manner.

23. The method of claim 14, further comprising interposing a non-continuous adhesive film between the rigid foam board and the film facer.

24. The method of claim 14, further comprising applying the non-continuous adhesive film to a surface of the film facer, and then overlaying the film facer and the non-continuous adhesive film applied thereto on the rigid foam board.

25. The method of claim 23, wherein the non-continuous adhesive film interposed is mechanically perforated.

26. The method of claim 14, wherein the rigid foam board comprises a first major surface and a second major surface parallel to the first major surface, the first major surface being at covered by the film facer and the second major surface configured for attachment to a building, a drainage channel being formed on the first major surface to provide at least one recessed channel surface, and wherein the method further comprises selectively non-continuously applying the adhesive with respect to the first major surface and the recessed channel surface.

27. The method of claim 26, further comprising applying the adhesive to one or the other but not both of the first major surface and the recessed channel surface.

28. The method of claim 26, further comprising forming the drainage channel on the first major surface.

29. A laminated building sheathing comprising a rigid foam board, the rigid foam board comprising a first major surface and a second major surface parallel to the first major surface, the first major surface configured for being covered by cladding and the second major surface configured for contact with a building, a drainage channel being formed on the first major surface and a moisture distribution feature being provided on the second major surface.

30. The laminated building sheathing of claim 29, wherein the moisture distribution feature comprises an air passageway.

31. The laminated building sheathing of claim 29, further comprising a facer applied to one or both of the first major surface and the second major surface of the rigid foam board.

32. The laminated building sheathing of claim 29, wherein the facer comprises a vapor-permeable film.

33. A method of fabricating a laminated building sheathing, the method comprising:
forming a drainage channel in a first major surface of the rigid foam board, the first major surface configured for being covered by cladding;
forming a moisture distribution feature on the second major surface, the second major surface configured for contact with a building.

34. The method of claim 33, wherein the moisture distribution feature comprises an air passageway.

35. The method of claim 33, further comprising applying a facer to one or both of the first major surface and the second major surface of the rigid foam board.

36. The method of claim of claim 35, wherein the facer comprises a vapor-permeable film.
